(19) United States
(12) Patent Application Publication
(10) Pub. No.: US 2018/0347527 A1
(43) Pub. Date: Dec. 6, 2018

(54) GASOLINE DIRECT-INJECTION RAIL

(71) Applicant: USUI CO., LTD., Sunto-gun, Shizuoka (JP)

(72) Inventor: Shuji SUZUKI, Sunto-gun, Shizuoka (JP)

(21) Appl. No.: 15/779,529

(22) PCT Filed: Oct. 13, 2016
(86) PCT No.: PCT/JP2016/080361

§ 371 Date: May 28, 2018

(30) Foreign Application Priority Data
Dec. 4, 2015 (JP) 2015-237410

(51) Int. Cl. F02M 55/02; F02M 37/00; F02M 63/02

(52) U.S. Cl. CPC F02M 55/025; F02M 37/0017; F02M 2700/072; F02M 2700/05; F02M 63/0225

(57) ABSTRACT

To make it possible to prevent damage to a brazed part without increasing the thickness of a rail body even when the rail body and an end cap are fixed to each other by brazing, in view of high-pressure gasoline direct injection systems of the future. A gasoline direct injection rail comprising end caps 2 disposed inside respective ends of a rail body 1, with an outer circumference 3 of each end cap 2 and an inner circumference 4 of the rail body 1 being fixed to each other by brazing, wherein a reinforcing ring 6 having an axial length L of L≥5 mm is provided on the outer circumference 3 of the rail body 1; a first end 10 on an end cap 2 side of the reinforcing ring 6 is positioned so as not to overlap a brazed part 12 between the rail body 1 and the end cap 2; a distance X from the first end 10 of the reinforcing ring 6 to a distal end 13 of the brazed part 12 is 0 mm≤X≤15 mm; and a thickness of the reinforcing ring 6 is 40% or more of a thickness of the rail body 1.

### TECHNICAL FIELD

The present invention relates to a rail for gasoline direct injection.

### BACKGROUND ART

Heretofore, a gasoline direct injection rail as disclosed in Patent Literature 1 wherein end caps are disposed inside the respective ends of a rail body is commonly used. In particular, there is a gasoline direct injection rail as shown in FIG. 7 wherein an inner circumference (33) of a rail body (31) and an outer circumference (34) of an end cap (32) are fixed to each other by brazing in order to fix the end cap (32) to the rail body (31) such that they are unlikely to be disengaged.

### CITATION LIST

### Patent Literature

Patent Literature 1: JP 2012-97690A

### DISCLOSURE OF THE INVENTION

### Problems to Be Solved By the Invention

However, when the rail body (31) and the end cap (32) are fixed to each other by brazing as described above, an internal pressure exerted on a fuel flowing part as indicated by the arrows in FIG. 8 causes the rail body (31) to be deformed in the diameter increasing direction and, accordingly, force that acts to detach a brazed part (35) is created due to this deformation. Therefore, in view of high-pressure systems of the future, there is a concern that, with the thickness of the conventional rail body (31), the brazed part (35) between the end cap (32) and the rail body (31) is damaged from the distal end (36) side of the brazed part (35). A possible means for avoiding such a situation is to increase the thickness of the rail body (31) so as to be greater than the thickness that is conventionally provided. However, an increased thickness results in an increased volume of the rail body (31). Accordingly, heat is less likely to be transferred, and the temperature cannot be raised to the melting temperature of a brazing filler metal at the time of brazing, thus making it difficult to perform brazing and, also, deteriorating the fuel efficiency from gasoline combustion due to an increased weight.

Hence, an object of the present invention is to solve the above-described problem, i.e., to make it possible to prevent damage to a brazed part without increasing the thickness of a rail body even when the rail body and an end cap are fixed to each other by brazing, in view of high-pressure gasoline direct injection systems of the future.

### Means for Solving the Problem

The first invention of the present application solves the above-described problem and is a gasoline direct injection rail comprising end caps disposed inside respective ends of a rail body, with an outer circumference of each end cap and an inner circumference of the rail body being fixed to each other by brazing, wherein

a reinforcing ring having an axial length L of L≥5 mm is provided on an outer circumference of the rail body;

a first end on an end cap side of the reinforcing ring is positioned so as not to overlap a brazed part between the rail body and the end cap;

a distance X from the first end of the reinforcing ring to a distal end of the brazed part is 0 mm≤X≤15 mm; and

a thickness of the reinforcing ring is 40% or more of a thickness of the rail body.

The second invention of the present application is a gasoline direct injection rail comprising end caps disposed inside respective ends of a rail body, with an outer circumference of each end cap and an inner circumference of the rail body being fixed to each other by brazing, wherein

a reinforcing ring is provided on an outer circumference of the rail body;

a first end on an end cap side of the reinforcing ring is positioned so as to overlap a brazed part between the rail body and the end cap;

a distance Y from a distal end of the brazed part to a second end of the reinforcing ring is Y≥5 mm; and

a thickness of the reinforcing ring is 40% or more of a thickness of the rail body.

Here, a finite element analysis was performed to determine a stress reducing effect attained when an internal pressure was exerted on the rail body in the case where the rail body was provided with a reinforcing ring. This finite element analysis is briefly explained as follows: first, a plurality of reinforcing rings, each having a thickness that is 40% of the thickness of the rail body and an axial length L of 4, 5, 10, or 30, were provided; and the relationship between a stress ratio and a distance X from the first end of the reinforcing ring to the distal end of the brazed part concerning each reinforcing ring was analyzed. The results of the analysis are shown in FIG. 2A. The above stress ratio indicates the ratio between the stress generated when the rail body is not provided with a reinforcing ring and the stress generated when the rail body is provided with a reinforcing ring, and is calculated according to a mathematical expression: Stress ratio=(Stress generated with reinforcing ring)/(Stress generated without reinforcing ring on rail body). A stress ratio of 1.0 means no stress reducing effect, and a value closer to 0 indicates a greater stress reducing effect.

The results of this finite element analysis verified that, as shown in FIG. 2A, when the reinforcing ring has a length L=4, the stress ratio is not reduced so much from 1.0 irrespective of the value of X, whereas in the case of L=5, 10, and 30, the stress ratio is clearly reduced from 1.0 as X is closer to 0. In accordance with these results, the axial length L of the reinforcing ring is L≥5 mm in the first invention of the present application, and the distance Y from the distal end of the brazed part to the second end of the reinforcing ring is Y≥5 mm in the second invention of the present application.

Then, two types of reinforcing rings, each having an axial length L of 10 mm and a thickness that was 20% or 40% of the thickness of the rail body, were provided, and the relationship between the stress ratio and the distance X from the first end of the reinforcing ring to the distal end of the brazed part concerning each reinforcing ring was analyzed as well. The results of the analysis are shown in FIG. 2B.

The results of this finite element analysis verified that, as shown in FIG. 2B, when the thickness ratio relative to the rail body is 20%, a reduction in the stress ratio is barely observed, whereas when the thickness ratio is 40%, the stress ratio is clearly decreased as X is closer to 0. In accordance with these results, the thickness of the reinforcing ring is 40% or more of the thickness of the rail body in the first and second inventions of the present application.

As shown in FIG. 2A and FIG. 2B, when X is 15 mm or more, the stress ratio remains 1.0. Therefore, no stress ratio reduction can be expected from providing a reinforcing ring when X is 15 mm or more, and thus the range of the distance X from the first end of the reinforcing ring to the distal end of the brazed part is 0 mm≤X≤15 mm in the first invention of the present application.

Since it is an essential requirement of the second invention of the present application that the first end on the end cap side of the reinforcing ring is positioned so as to overlap the brazed part between the rail body and the end cap, the distance from the first end of the reinforced ring to the distal end of the brazed part does not become a particular problem.

In the first invention of the present application, the axial length L of the reinforcing ring may be L≤30 mm. No significant stress reducing effect is observed when the axial length L of the reinforcing ring is greater than 30 mm and, in turn, problems, i.e., wasting the material as well as increasing the product weight, arise.

In the second invention of the present application, the distance Y from the distal end of the brazed part to the second end of the reinforcing ring may be Y≤30 mm. No significant stress reducing effect is observed when the distance Y from the distal end of the brazed part to the second end of the reinforcing ring is greater than 30 mm and, in turn, problems, i.e., wasting the material as well as increasing the product weight, arise.

In the first and second inventions of the present application, the reinforcing ring may be fixed to the rail body by way of brazing, shrink fitting, or welding.

### Effects of the Invention

As described above, in the first and second inventions of the present application, a reinforcing ring is provided on a part of the outer circumference of the rail body where the stress or the displacement is large, and thus deformation of the rail body in the diameter increasing direction can be suppressed. Therefore, in view of high-pressure gasoline direct injection systems of the future, even when the rail body and the end cap are fixed to each other by brazing, the thickness of the rail body does not need to be increased, and it is thus possible to prevent damage to the brazed part without increasing the weight of the rail body.

### BRIEF DESCRIPTION OF THE DRAWINGS

FIG. 1 is a cross-sectional view showing the first embodiment of the present invention.

FIG. 2A and FIG. 2B depict graphs showing the relationship between the stress ratio and the distance X from the first end of the reinforcing ring to the distal end of the brazed part.

FIG. 3 is a perspective view showing the first embodiment.

FIG. 4 is a cross-sectional view showing the second embodiment.

FIG. 5 is a cross-sectional view showing the third embodiment.

FIG. 6 is a perspective view showing the third embodiment.

FIG. 7 is a cross-sectional view showing a conventional example.

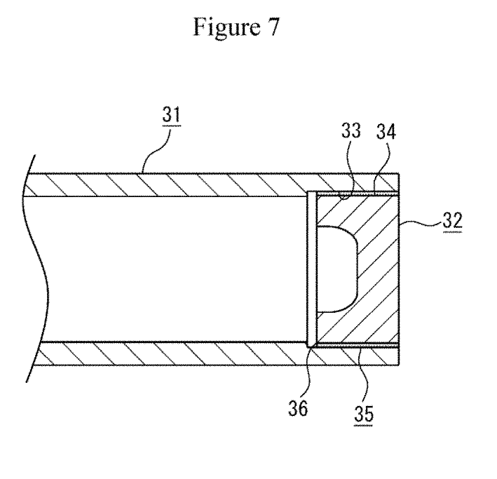

FIG. 8 is a cross-sectional view showing a conventional example when an internal pressure is exerted.

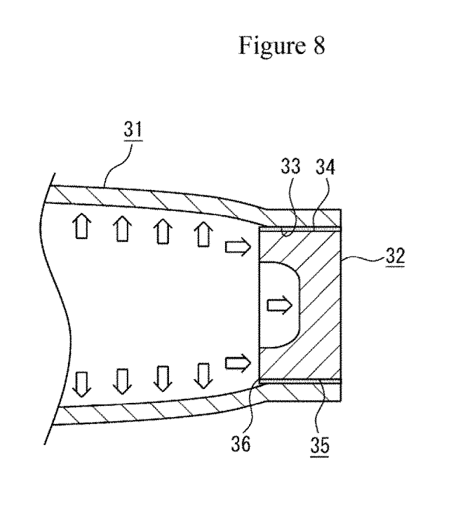

### MODES FOR CARRYING OUT THE INVENTION

### First Embodiment

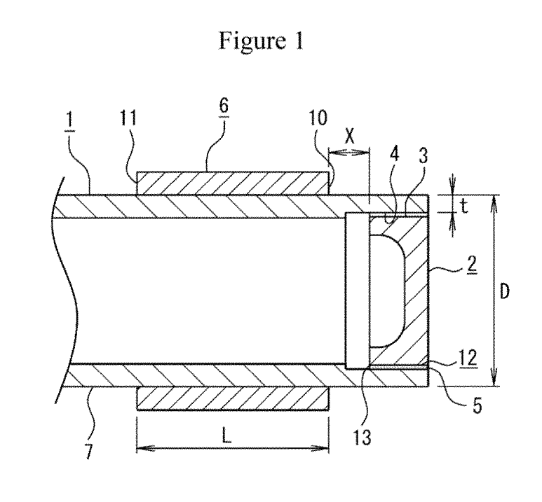

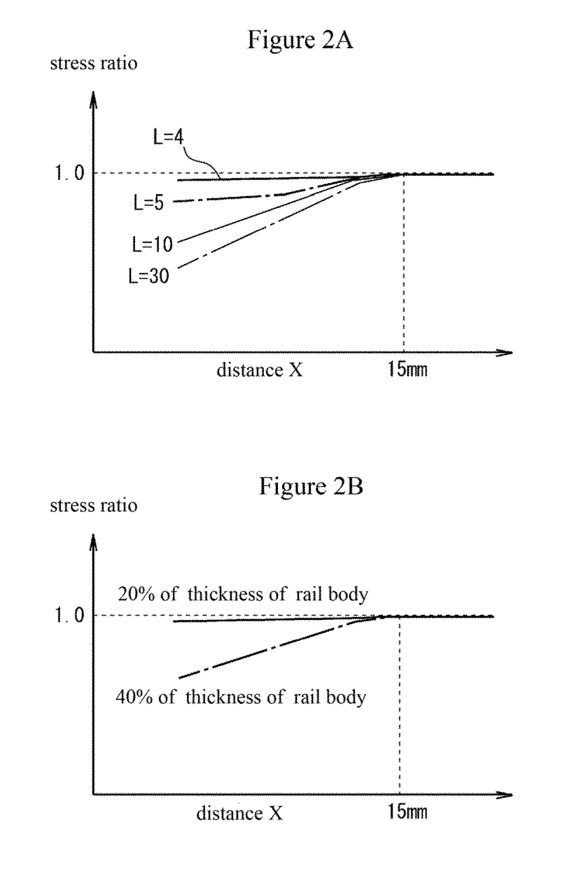

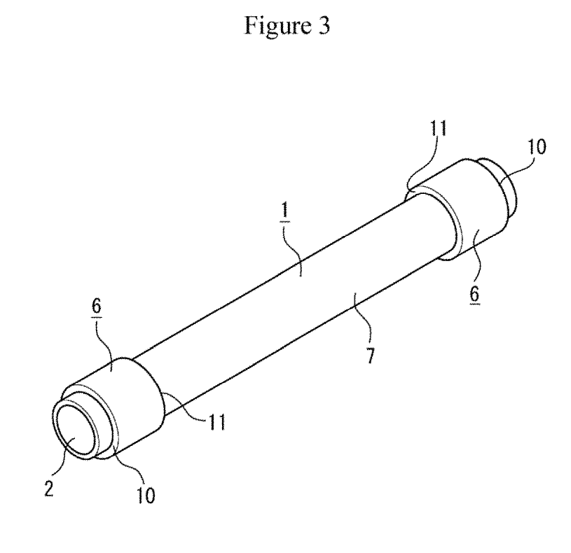

The first embodiment of the first invention of the present application will now be described below with reference to FIGS. 1 to 3. First, (1) indicates a rail body, and the rail body (1) has an outer diameter of 22 mm and an inner diameter of 17 mm. The ratio of a thickness t to an outer diameter D of the rail body (1) is 0.1. The rail body (1) is made of stainless steel. In this embodiment, the rail body (1) is made of stainless steel as described above, whereas the rail body (1) can also be made of steel in other embodiments. Cylindrical end caps (2), each having an outer diameter corresponding to the inner diameter of the rail body (1), are disposed inside the respective ends of the rail body (1).

A brazing filler metal (5) is disposed between an outer circumference (3) of each end cap (2) and an inner circumference (4) of the rail body (1) to fix the end cap (2) and the rail body (1) to each other by brazing. A reinforcing ring (6) is attached to an outer circumference (7) of the rail body (1). The reinforcing ring (6) is in a cylindrical shape and has an axial length L=20 mm, and the inner circumference thereof is fixed to the outer circumference (7) of the rail body (1) by way of brazing. In this embodiment as well as the second and third embodiments below, the reinforcing ring (6) is fixed to the rail body (1) by brazing as described above, but it is also possible in other embodiments that the reinforcing ring (6) is securely disposed on the rail body (1) by way of shrink fitting or welding.

The reinforcing ring (6) has a thickness that is 120% of the thickness t of the rail body (1). The reinforcing ring (6) and the end cap (2) are made of stainless steel or steel. The rail body (1) used in the gasoline direct injection rail of the present invention preferably have dimensions such that the outer diameter D is 10 mm to 25 mm, the inner diameter is 7 mm or more, and the ratio of the thickness t to the outer diameter D is t/D=0.1 to 0.25.

In this embodiment, as shown in FIG. 1, the reinforcing ring (6) is attached to the rail body (1) such that the first end on the end cap (2) side of the reinforcing ring (6) is positioned so as not to overlap a brazed part (12) between the rail body (1) and the end cap (2), and a distance X from a first end (10) of the reinforcing ring (6) to a distal end (13) of the brazed part (12) is X=5 mm.

As described above, the length L of the reinforcing ring (6) is L≥5 mm, the distance X from the first end (10) of the reinforcing ring (6) to the distal end (13) of the brazed part (12) is 0 mm≤X≤15 mm, and the thickness of the reinforcing ring (6) is 40% or more of the thickness of the rail body (1), and thereby the reinforcing ring (6) is provided on a part of the outer circumference (7) of the rail body (1) where the stress or the displacement generated due to an internal pressure is large. Accordingly, deformation of the rail body (1) in the diameter increasing direction can be suppressed, and it is thus possible to prevent damage to the brazed part (12).

### Second Embodiment

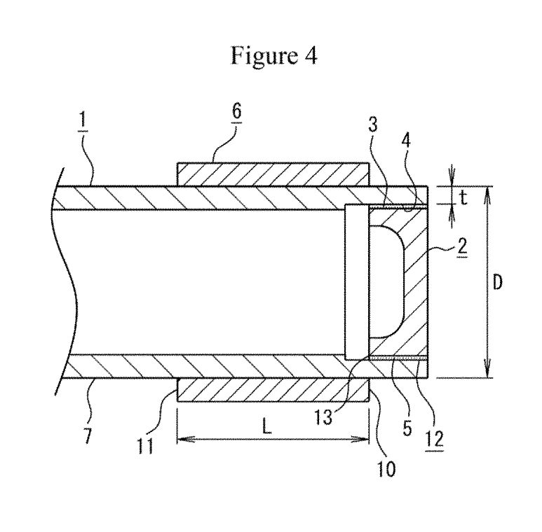

While the distance X from the first end (10) of the reinforcing ring (6) to the distal end (13) of the brazed part (12) is X=5 mm in the first embodiment, X is 0 mm in the second embodiment of the first invention of the present application as shown in FIG. 4. As for the other dimensions, the reinforcing ring (6) has an axial length L=20 mm, and the thickness thereof is 120% of the thickness of the rail body (1), as in the first embodiment. Thus, in the second embodiment as well, X is within a range of 0 mm≤X≤15 mm, moreover the length L of the reinforcing ring (6) is L≥5 mm, and the thickness of the reinforcing ring (6) is 40% or more of the thickness of the rail body (1), and thereby, in the second embodiment as well, the reinforcing ring (6) is provided on a part of the outer circumference (7) of the rail body (1) where the stress or the displacement is large. Accordingly, deformation of the rail body (1) in the diameter increasing direction is suppressed, thus making it possible to prevent damage to the brazed part (12).

### Third Embodiment

While the reinforcing ring (6) is securely disposed on the rail body (1) such that the first end (10) on the end cap (2) side of the reinforcing ring (6) is positioned so as not to overlap the brazed part (12) between the rail body (1) and the end cap (2) in the first and second embodiments above, the reinforcing ring (6) is securely disposed such that the first end (10) on the end cap (2) side of the reinforcing ring (6) is positioned so as to overlap the brazed part (12) between the rail body (1) and the end cap (2) in the third embodiment in the second invention of the present application.

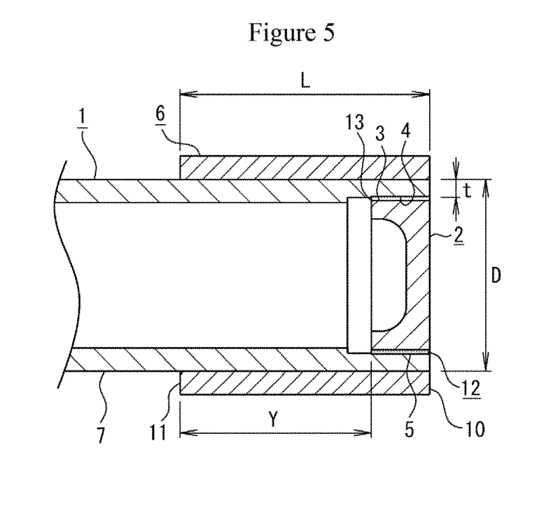

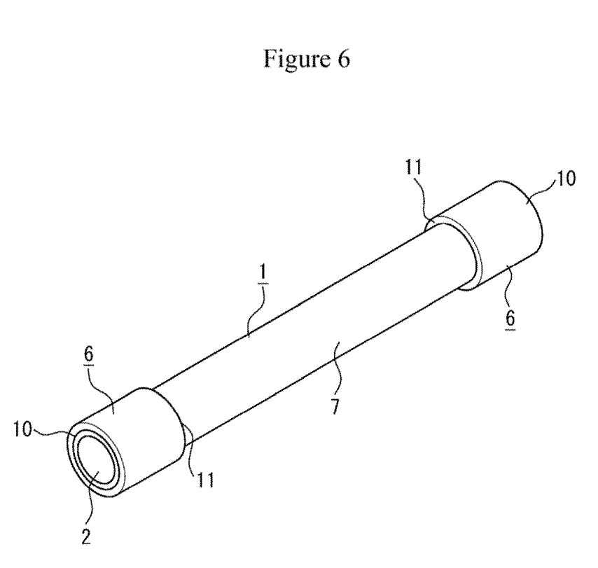

When the third embodiment is explained in reference to FIGS. 5 and 6, the outer diameter and the inner diameter of the rail body (1), the ratio between the outer diameter D and the thickness t of the rail body (1), and the material of the rail body (1) in this embodiment are the same as those in the first embodiment. The cylindrical end caps (2), each having an outer diameter corresponding to the inner diameter of the rail body (1), are disposed inside the respective ends of the rail body (1), and the outer circumference (3) of each end cap (2) and the inner circumference (4) of the rail body (1) are brazed to each other with the brazing filler metal (5). The reinforcing ring (6) is attached to the outer circumference (7) of the rail body (1). The reinforcing ring (6) is in a cylindrical shape and has an axial length L=30 mm, and the inner circumference thereof is fixed to the outer circumference (7) of the rail body (1) by way of brazing. The thickness of the reinforcing ring (6) is 120% of the thickness of the rail body (1).

As shown in FIGS. 5 and 6, the reinforcing ring (6) is attached to the rail body (1) such that the first end (10) on the end cap (2) side of the reinforcing ring (6) is positioned so as to overlap the brazed part (12) between the rail body (1) and the end cap (2), and the end face on the first end side of the rail body (1) is flush with the end face on the first end (10) side of the reinforcing ring (6). Moreover, the distance Y shown in FIG. 5 from the distal end (13) of the brazed part (12) between the rail body (1) and the end cap (2) to the second end (11) of the reinforcing ring (6) is Y=20 mm.

As described above, the reinforcing ring (6) is securely disposed on the rail body (1) such that the first end (10) on the end cap (2) side of the reinforcing ring (6) is positioned so as to overlap the brazed part (12) between the rail body (1) and the end cap (2), the distance Y from the distal end (13) of the brazed part (12) to the second end (11) of the reinforcing ring (6) is Y≥5 mm, and the thickness of the reinforcing ring (6) is 40% or more of the thickness of the rail body (1), and thereby the reinforcing ring (6) is provided on a part of the outer circumference (7) of the rail body (1) where the stress or the displacement generated in the rail due to an internal pressure is large. Accordingly, deformation of the rail body (1) in the diameter increasing direction can be suppressed, and it is thus possible to prevent damage to the brazed part (12).

### DESCRIPTION OF THE REFERENCE NUMERALS

1 Rail body
2 End cap
3 Outer circumference (End cap)
4 Inner circumference
6 Reinforcing ring
7 Outer circumference (Rail body)
10 First end
11 Second end
12 Brazed part
13 Distal end

1. A gasoline direct injection rail comprising end caps disposed inside respective ends of a rail body, with an outer circumference of each end cap and an inner circumference of the rail body being fixed to each other by brazing, wherein
a reinforcing ring having an axial length L of L≥5 mm is provided on an outer circumference of the rail body;
a first end on an end cap side of the reinforcing ring is positioned so as not to overlap a brazed part between the rail body and the end cap;
a distance X from the first end of the reinforcing ring to a distal end of the brazed part is 0 mm≤X≤15 mm; and
a thickness of the reinforcing ring is 40% or more of a thickness of the rail body.

2. A gasoline direct injection rail comprising end caps disposed inside respective ends of a rail body, with an outer circumference of each end cap and an inner circumference of the rail body being fixed to each other by brazing, wherein a reinforcing ring is provided on an outer circumference of the rail body;
a first end on an end cap side of the reinforcing ring is positioned so as to overlap a brazed part between the rail body and the end cap;
a distance Y from a distal end of the brazed part to a second end of the reinforcing ring is Y≥5 mm; and
a thickness of the reinforcing ring is 40% or more of a thickness of the rail body.

3. The gasoline direct injection rail according to claim 1, wherein the axial length L of the reinforcing ring is L≤30 mm.

4. The gasoline direct injection rail according to claim 2, wherein the distance Y from the distal end of the brazed part to the second end of the reinforcing ring is Y≤30 mm.

5. The gasoline direct injection rail according to claim 1, wherein the reinforcing ring is fixed to the rail body by way of brazing, shrink fitting, or welding.
